(19) United States
(12) Patent Application Publication
(10) Pub. No.: US 2026/0270718 A1
(43) Pub. Date: Sep. 10, 2026

(54) METHOD AND APPARATUS FOR CANARY DEPLOYMENT IN GNODEB

(71) Applicant: Telefonaktiebolaget LM Ericsson (publ), Stockholm (SE)

(72) Inventors: Seunghee YI, Seoul (KR); Maximilian POPESCU, Skärblacka (SE); Cormac MULLALLY, Athlone, Westmeath (IE)

(21) Appl. No.: 18/868,970

(22) PCT Filed: May 27, 2022
(86) PCT No.: PCT/EP2022/064429

§ 371 Date: Nov. 25, 2024

(51) Int. Cl. H04W 24/02; H04L 41/5009; H04W 16/18

(52) U.S. Cl. CPC H04W 24/02; H04L 41/5009; H04W 16/18

(57) ABSTRACT

A method for assigning a user plane workload during canary deployment of software modification of a gNodeB, the gNodeB including a Central Unit (gNB-CU). The method includes operating the gNB-CU-UP as a plurality of CU-UP instances including a first set of CU-UP instances, instantiating a new CU-UP instance running a modified software compared to the first set of CU-UP instances. Further, the method includes receiving instructions to modify selection policy for distributing a user plane workload between the new CU-UP instance and the first set of CU-UP instances. The method also includes instantiating a second set of CU-UP instances including a plurality of CU-UP instances running said modified software if it is determined that the new CU-UP instance operates correctly and directing all user plane workload to CU-UP instances running said modified software.

### TECHNICAL FIELD

The present invention relates to wireless communications networks, in general, and in particular to software updates of Radio Access Network.

### BACKGROUND

A wireless communications network of 5th generation (5G) comprises a set of gNodeBs connected to a 5G Core Network (5GC) through an NG interface as illustrated in FIG. 1. As shown in FIG. 1 two (and more) gNBs can be interconnected through the Xn interface. A gNB may comprise a gNB-CU (Central Unit) and one or more gNB-DU(s) (Distributed Unit). A gNB-CU and a gNB-DU are connected via F1 interface. Additionally, gNB-CU can be decomposed into two entities: gNB-CU-CP for control plane and gNB-CU-UP for user plane. Both are interconnected via E1 interface as shown in FIG. 2.

Typically, a gNB is implemented on a special HW platform and is described as a Physical Network Function (PNF). For a gNBs implemented as a Physical Network Function its capacity is statically fixed during lifetime. During an upgrade of software in a gNB with a new version, the gNB requires a check to be carried out by an operator or a support engineer to see if it works as expected before it is deployed on large scale.

The gNB-CU-CP selects an appropriate gNB-CU-UP for services requested for User Equipment (UE) served by the gNB. If multiple gNB-CU-UPs are available for the specific UE service, gNB-CU-CP allocates gNB-CU-UP for a new UE considering each gNB-CU-UP's traffic handling capacity.

According to 3GPP TS 38.463 “NG-RAN; E1 Application Protocol (E1AP)”, 16.6.0 standard, capacity of a gNB-CU-UP may be known to gNB-CU-CP via E1 signaling and information about capacity may be carried in an optional Information Element called gNB-CU-UP Capacity IE. This Information element may be present in the following messages:
GNB-CU-UP E1 SETUP REQUEST
GNB-CU-CP E1 SETUP RESPONSE
GNB-CU-UP CONFIGURATION UPDATE

When gNB-CU-UP Capacity IE is contained in the message, the gNB-CU-CP shall take this IE into account in order to load-balance among different gNB-CU-UPs.

However, in a new type of gNB based on Cloud Network Functions (CNF), these legacy assumptions (i.e. fixed capacity and engineer's support during upgrade) may not be true anymore. The capacity of a cloud-based gNB is variable according to the operator's needs and can be changed during operation with very little or even without any traffic interruption. Also, in case of gNB-CU, a gNB implemented using Cloud Network Functions does not need any special hardware and it is possible to deploy new software version more easily. A Radio Access Network (RAN) with cloud based gNBs is also referred to as Cloud RAN. With the capacity of a cloud-based gNB dynamically changing and the drive to deploy new version of software implementing the functions of the cloud-based gNB automatically, without a need for intervention from a field engineer the approach for load balancing known from gNBs deployed as Physical Network Function (PNF) is no longer valid.

### SUMMARY

According to a first aspect of the present invention there is provided a method for assigning a user plane workload during canary deployment of software modification of a gNodeB. The gNodeB comprises a Central Unit (gNB-CU), wherein the user plane workload processing is carried out by a user plane entity of the gNB-CU (gNB-CU-UP). The method performed at the gNB-CU comprises operating the gNB-CU-UP as a plurality of CU-UP instances including a first set of CU-UP instances and instantiating a new CU-UP instance running a modified software compared to the first set of CU-UP instances. The method also comprises receiving, at a control plane entity of the gNB-CU (gNB-CU-CP), instructions to modify selection policy for distributing a user plane workload between the new CU-UP instance and the first set of CU-UP instances by adjusting the amount of the user plane workload to be allocated to the new CU-UP instance. Further, the method comprises instantiating a second set of CU-UP instances comprising a plurality of CU-UP instances running said modified software if it is determined that the new CU-UP instance operates correctly and directing all user plane workload to CU-UP instances running said modified software.

According to a second aspect of the present invention there is provided a Central Unit of a gNodeB, gNB-CU, for assigning a user plane workload during canary deployment of software modification of the gNB-CU, wherein processing a user plane workload is carried out by a user plane entity of the gNB-CU, gNB-CU-UP. The gNB-CU comprises a processing circuitry and a memory, the memory has stored thereon instructions executable by the processing circuitry such that the gNB-CU is operative during the canary deployment of the software modification to operate the gNB-CU-UP as a plurality of CU-UP instances including a first set of CU-UP instances and to instantiate a new CU-UP instance running a modified software compared to the first set of CU-UP instances. The gNB-CU is further operative to receive, at a control plane entity of the gNB-CU (gNB-CU-CP), instructions to modify selection policy for distributing a user plane workload between the new CU-UP instance and the first set of CU-UP instances by adjusting the amount of the user plane workload to be allocated to the new CU-UP instance. The gNB-CU is further operative to deploy a second set of CU-UP instances comprising a plurality of CU-UP instances running said modified software if it is determined that the new CU-UP instance operates correctly and direct all user plane workload to CU-UP instances running said modified software.

Further features of the present invention are as claimed in the dependent claims.

### BRIEF DESCRIPTION OF THE DRAWINGS

The present invention will be understood and appreciated more fully from the following detailed description taken in conjunction with the drawings in which:

FIG. 1 is a diagram illustrating architecture of a wireless communications network of 5th generation;

FIG. 2 is a diagram illustrating architecture of a gNodeB;

FIG. 3 is a flowchart illustrating an embodiment of a method for assigning a user plane workload during canary deployment of software modification of a gNodeB;

FIG. 4 is a diagram illustrating high-level view of an embodiment of the method illustrated in FIG. 3;

FIG. 5A to FIG. 5C are message sequence diagrams illustrating embodiments of the method for assigning a user plane workload during canary deployment of software modification of a gNodeB;

FIG. 6 is a diagram illustrating one embodiment of an apparatus for implementing the method for assigning a user plane workload during canary deployment of software modification of a gNodeB.

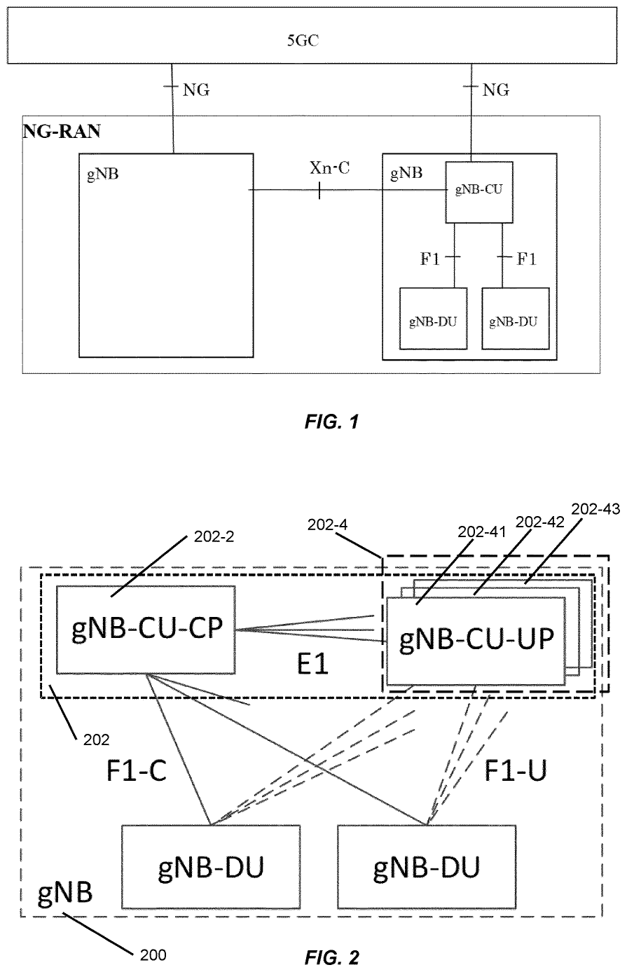

### DETAILED DESCRIPTION

In the following description, for purposes of explanation and not limitation, specific details are set forth such as particular architectures, interfaces, techniques, etc. in order to provide a thorough understanding of the invention. However, it will be apparent to those skilled in the art that the invention may be practiced in other embodiments that depart from these specific details. In other instances, detailed descriptions of well-known devices, circuits, and methods are omitted so as not to obscure the description of the invention with unnecessary details.

Reference throughout the specification to “one embodiment” or “an embodiment” means that a particular feature, structure, or characteristic described in connection with an embodiment is included in at least one embodiment of the present invention. Thus, the appearance of the phrases “in one embodiment” or “in an embodiment” in various places throughout the specification are not necessarily all referring to the same embodiment. Further, the particular features, structures or characteristics may be combined in any suitable manner in one or more embodiments.

Various embodiments disclosed in the document are described in the context of NR Standalone (SA) architecture of a 5G network. However, it would be clear to a person skilled in the art that the same mechanisms are applicable to NR Non-Standalone architecture as well.

The inventors recognised that in order to fully benefit from the ability of deploying new (or modified) software version with little or even without interrupting traffic there is a need for a solution that will cover both dynamic capacity and easy software deployment in Cloud RAN. The solution to be disclosed in this document is not limited to Cloud RAN only, but is also applicable to software updates of gNBs implemented as Physical Network Functions. One way to deploy new versions of software that is known is so called canary deployment. In a canary deployments a new software version is released to a subset of users or servers. In this way the new version may be tested on a small subset of servers or users and if it operates as expected then the new version may be rolled out to the rest of the servers or users.

The inventors further recognised that in a Radio Access Network (RAN), canary deployment needs to be controlled so that the amount of traffic (workload) handled by the new software version is limited such that in the case of the new version not performing well enough the damage caused to the traffic handled by the RAN will be limited and remedial actions would not require significant amount of resources. The canary deployment serves as an early warning indicator with less impact on service downtime-if the canary deployment fails, the rest of the servers aren't impacted. Hence the embodiments of the invention by modifying selection policy in the case of canary deployment limit the traffic handled by the upgraded node (node with the upgraded software) and limit the potential damage if something goes wrong.

With reference to FIGS. 2, 3 and 4 an embodiment of a method for assigning a user plane workload during canary deployment of software modification of a gNodeB, is now to be described. The gNodeB 200, as illustrated in FIG. 2 comprises a Central Unit (gNB-CU), 202, wherein the user plane workload processing is carried out by a user plane entity of the gNB-CU (i.e. gNB-CU-UP), 202-4. The method is performed at the gNB-CU, 202, and comprises operating, 302, the gNB-CU-UP, 202-4, as a plurality of CU-UP instances, 202-41-202-43 including a first set of CU-UP instances 202-41-202-43. In the next step the method comprises instantiating, 304, a new CU-UP instance, 202-51, running a modified software compared to the first set of CU-UP instances, 202-41-202-43. The method then comprises receiving instructions, 306, at a control plane entity of the gNB-CU (i.e. gNB-CU-CP), 202-2, to modify selection policy for distributing a user plane workload between the new CU-UP instance, 202-51 and the first set of CU-UP instances, 202-41-202-43, by adjusting the amount of the user plane workload to be allocated to the new CU-UP instance, 202-51. If it is determined that the new CU-UP instance, 202-51, operates correctly, 308-yes, the method comprises instantiating, 310, a second set of CU-UP instances, comprising a plurality of CU-UP instances running said modified software 202-51, 202-52 and 202-53 and directing, 312, all user plane workload to said CU-UP instances running said modified software 202-51, 202-52 and 202-53. In one embodiment a router or a switch, 402, may be used to direct traffic (workload) to the CU-UP instances in accordance with the selection policy. On the other hand, if it is determined that the new CU-UP instance, 202-51, does not operate correctly, 308-no, the method comprises inactivating the new CU-UP instance, 314, and operating the gNB-CU-UP as a plurality of CU-UP instances running the original version of software (i.e. the first set of CU-UP instances, 302).

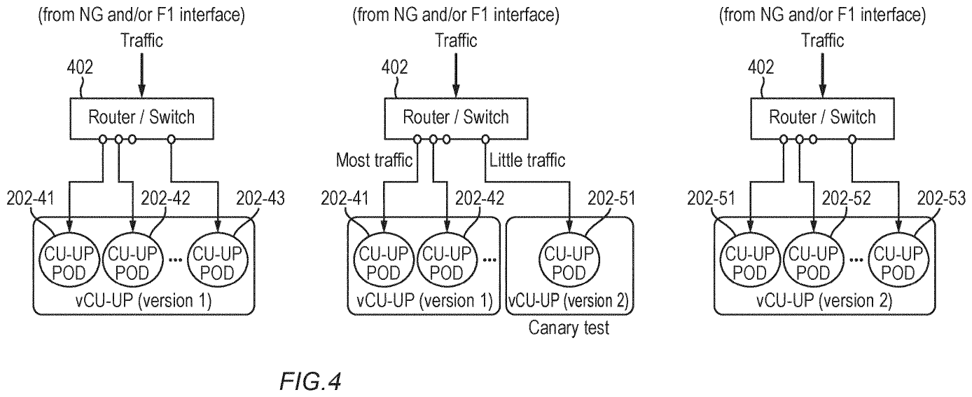

With reference to FIG. 4 the canary deployment in a gNB in one embodiment od is a stepwise software deployment involving the following operations:
All traffic is handled by gNB-CU-UP instances 202-41-202-43.
Instantiate a new gNB-CU-UP instance, 202-51 (modified software version) to handle portion of traffic by adjusting UP (user plane) selection policy by gNB-CU-CP, whereas most traffic is still handled by the old gNB-CU-UP instances 202-41-202-43.
Checking if the canary deployment operates successfully or not.
If successful, deploy more gNB-CU-UPs with the modified software to handle all traffic (202-52, 202-53).
If not successful, go back to traffic being handled by gNB-CU-UP instances 202-41-202-43 running the original software version.

The advantage of this solution is that it allows to control interaction between gNB-CU-CP and gNB-CU-UP during canary deployment and through this interaction it's possible to minimize the downtime that may be caused by software fault. Additionally, the solution in its embodiments considers dynamic capacity adjustment in run-time.

To control canary deployment of gNB-CU-UP, the gNB-CU-UP Capacity IE (Information Element) defined in 3GPP TS 38.463 v16.9.0 in E1AP interface is used and may be extended to contain the additional flag (the added parameter in italics):

gNB-CU-UP Capacity IE

| IE/Group | | | IE type and | Semantics |
|---|---|---|---|---|
| Name | Presence | Range | reference | description |
| gNB-CU-UP | M | | INTEGER | |
| Capacity | | | (0 . . . 255) | |
| gNB-CU-UP | O | | ENUMERATED | Indicates |
| Canary | | | (true, . . . ) | whether |
| | | | | canary |
| | | | | deployment |
| | | | | is tried |

The “gNB-CU-UP Canary” parameter is newly introduced within gNB-CU-UP Capacity IE. Instead of introducing this “gNB-CU-UP Canary” parameter as a separate IE in a preferred embodiment the parameter is introduced as part of the existing gNB-CU-UP Capacity IE. The advantage of this approach is that it does not require modification of E1AP messages (i.e. messages GNB-CU-UP E1 SETUP REQUEST, GNB-CU-CP E1 SETUP RESPONSE, GNB-CU-UP CONFIGURATION UPDATE defined in 3GPP TS 38.463 v16.9.0).

For the canary deployment using the modified gNB-CU-UP Capacity IE, the following behavior shall be updated or added:
gNB-CU-CP: update of UP selection policy/algorithm. In embodiments of this solution selection of CU-UP instance is about allocating traffic so that the newly deployed software module receives no more traffic than a defined threshold.
gNB-CU-UP: a functionality implementing a canary controller is implemented in the new CU-UP instance. In a preferred embodiment this functionality uses a trigger from the network operator to initiate canary deployment, i.e. to send a message indicating that a canary deployment is tried.

Alternatively, the parameter indicating deployment of the new CU-UP instance running modified software may be included in an information element dedicated to deployment of CU-UP instances running modified software. In this alternative embodiment the separate, dedicated gNB-CU-UP Canary IE may be defined as follows:

gNB-CU-UP Canary IE

| IE/Group | | | IE type and | Semantics |
|---|---|---|---|---|
| Name | Presence | Range | reference | description |
| gNB-CU-UP | O | | ENUMERATED | Indicates |
| Canary | | | (true, . . . ) | whether |
| | | | | canary |
| | | | | deployment |
| | | | | is tried |

In this embodiment, except for the location of the parameter, overall behavior/handling is the same as for the first embodiment in which the parameter is added to the gNB-CU-UP Capacity IE. The sender of a message including the gNB-CU-UP Canary IE in a preferred embodiment is the new CU-UP instance.

In a preferred embodiment the amount of the user plane workload assigned to the new CU-UP instance does not exceed a threshold. The threshold may be specified by an operator and by specifying the first threshold at certain value damage to the operations of the network may be limited if the new (or modified) software version of the CU-UP instance fails. If, however, KPI(s) of the new software indicate that the new software operates correctly (as expected), then, in a preferred embodiment the first threshold defining the maximum amount of the user plane workload to be assigned to the new CU-UP instance may be increased. The increase is implemented before deploying the second set of CU-UP instances. Increasing the first threshold allows for stress-testing of the new software.

By using canary deployment in a gNB, it is possible to deploy a new (or modified) gNB-CU-UP software with small/reduced risk and downtime. After successful canary deployment, gNB-UP-UP running the new software version can proceed to the full-fledged service state without operator's touch. Thanks to the proposed gNB-CU-UP Canary flag (i.e. parameter or a dedicated Information Element), canary deployment can be tried with variable traffic volume according to the operator's needs. Also, gNB-CU-CP can decide easily if canary deployment is applied. If necessary, gNB-CU-CP may select the UP selection policy dedicated to canary deployment explicitly with new gNB-CU-UP Canary flag.

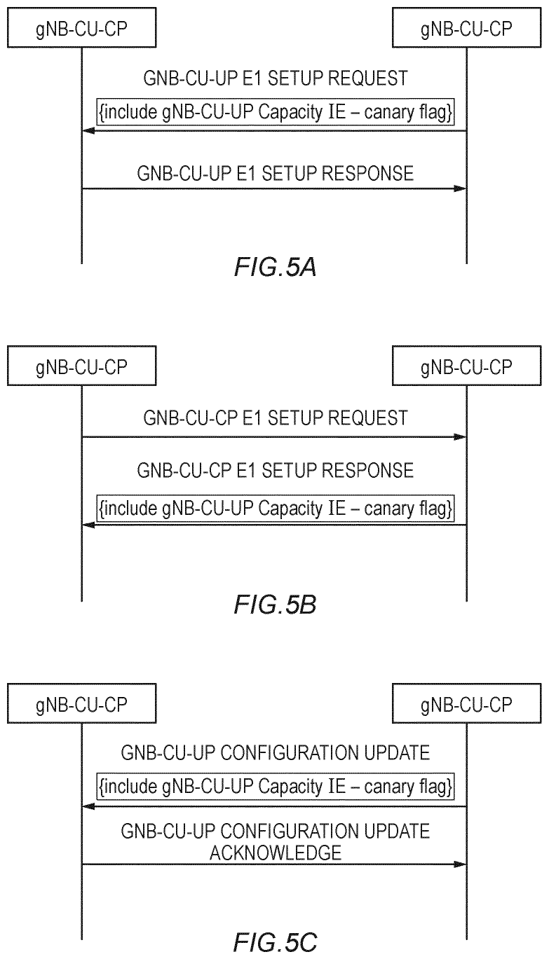

In a preferred embodiment the gNB-CU-CP receives a parameter indicating deployment of the new CU-UP instance running modified software. In this preferred embodiment the gNB-CU-UP Capacity IE modified by including the canary flag (gNB-CU-UP Canary parameter) may be exchanged in the following E1AP messages (illustrated in FIGS. 5A-5C):

GNB-CU-UP E1 SETUP REQUEST.

GNB-CU-CP E1 SETUP RESPONSE.

GNB-CU-UP CONFIGURATION UPDATE

This means a gNB-CU-CP can understand if new software version is installed in gNB-CU-UP by checking gNB-CU-UP Capacity IE for presence and value of the gNB-CU-UP Canary parameter. In a preferred embodiment the sender of the three E1AP messages is the new CU-UP instance.

In an embodiment the messages carrying the Canary flag (i.e. parameter or a dedicated Information Element) listed above are sent by the newly deployed instance of gNB-CU-UP running the modified software.

In operation, the gNB-CU-UP monitors at least one Key Performance Indicator, KPI, of the new CU-UP instance. In one embodiment the operation of monitoring of the at least one KPI is carried out by the new CU-UP instance. The obtained KPIs values may be then reported to a management system or may be reported to the network operator. In a further alternative embodiment, the network management system may report the KPI values to the operator of the communications network where the gNodeB operates. As mentioned earlier, determining that the new CU-UP instance operates correctly may comprises determining that the at least one Key Performance Indicator reached a threshold defined for this KPI.

The determination whether the new CU-UP instance works correctly (the at least one KPI reaching a threshold or multiple KPIs reaching their respective thresholds) may be done in various embodiments by the new CU-UP instance, the management system or the network operator. All these entities know measured at least one KPI and their respective thresholds. Different management models may be introduced in which different entities may decide on full-scale deployment of the modified/new software version once it is determined the new CU-UP instance works correctly.

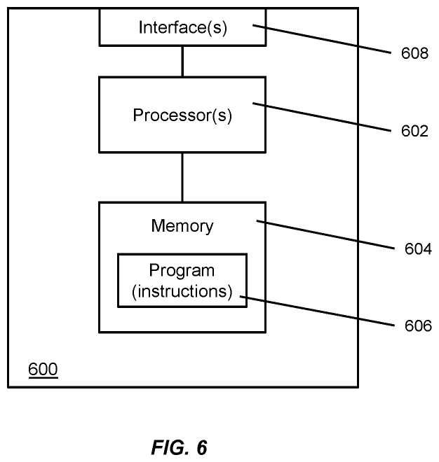

FIG. 6 illustrates one embodiment of an apparatus (Central Unit of a gNodeB, gNB-CU), 600, which implements the method of for assigning a user plane workload during canary deployment of software modification of a gNodeB described earlier. The apparatus, 600, comprises a processing circuitry, 602, and a memory, 604. The memory, 604, contains instructions executable by the processing circuitry, 602, such that the gNB-CU, 600, is operative to operate the gNB-CU-UP as a plurality of CU-UP instances including a first set of CU-UP instances. The gNB-CU, 600, is further operative to instantiate a new CU-UP instance running a modified software compared to the first set of CU-UP instances and receive, at a control plane entity of the gNB-CU (gNB-CU-CP), instructions to modify selection policy for distributing a user plane workload between the new CU-UP instance and the first set of CU-UP instances. The distributing of the user plane workload is realised by adjusting the amount of the user plane workload to be allocated to the new CU-UP instance Further, the gNB-CU, 600, is operative to deploy a second set of CU-UP instances comprising a plurality of CU-UP instances running said modified software if it is determined that the new CU-UP instance operates correctly and direct all user plane workload to CU-UP instances running said modified software.

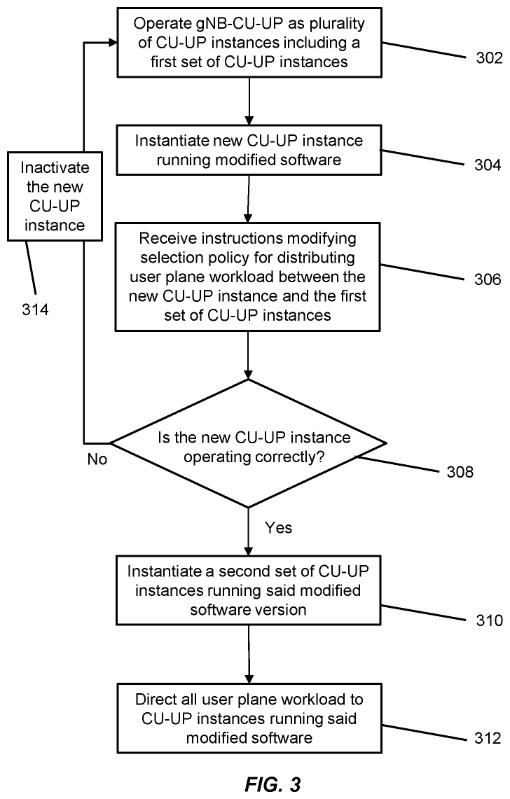

The apparatus, 600, may include a processing circuitry (one or more than one processor), 602, coupled to an interface, 608, and to the memory 604. The apparatus, 600, may comprise more than one interface. By way of example, the interface 608, the processor(s) 602, and the memory 604 may be connected in series as illustrated in FIG. 6. Alternatively, these components 602, 604 and 608 may be coupled to an internal bus system of the apparatus, 600. The memory 604 may include a Read-Only-Memory (ROM), e.g., a flash ROM, a Random Access Memory (RAM), e.g., a Dynamic RAM (DRAM) or Static RAM (SRAM), a mass storage, e.g., a hard disk or solid state disk, or the like. The memory, 604, may contain a computer program (software or instructions), 606, and/or control parameters. The memory, 604, may include suitably configured program code to be executed by the processor(s), 602, so as to implement the above-described method as explained in connection with FIGS. 3-5.

It is to be understood that the structures as illustrated in FIG. 6 are merely schematic and that the apparatus (Central Unit of a gNodeB, gNB-CU), 600, may actually include further components which, for the sake of clarity, have not been illustrated, e.g., further interfaces or processors. Also, it is to be understood that the memory, 604, may include further program code for implementing other and/or known functionalities.

According to some embodiments, also a computer program may be provided for implementing functionalities of the apparatus, 600, e.g., in the form of a physical medium storing the program code and/or other data to be stored in the memory 604, or by making the program code available for download or by streaming.

It is also to be understood that the apparatus, 600, may be provided as a virtual apparatus. In one embodiment, the apparatus, 600, may be provided in distributed resources, such as in cloud resources. When provided as virtual apparatus, it will be appreciated that the memory, 604, processing circuitry, 602, and physical interface(s), 606, may be provided as functional elements. The functional elements may be distributed in a logical network and not necessarily be directly physically connected. It is also to be understood that the apparatus, 600, may be provided as single-node devices, or as a multi-node system. In some embodiments the apparatus (Central Unit of a gNodeB, gNB-CU), 600, may be implemented using one or multiple general-purpose computer, or commercial of the shelf (COTS) computer or computers.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

It should be noted that the above-mentioned examples illustrate rather than limit the disclosure, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method for assigning a user plane workload during canary deployment of software modification of a gNodeB, the gNodeB comprising a Central Unit (gNB-CU), wherein the user plane workload processing is carried out by a user plane entity of the gNB-CU (gNB-CU-UP), the method performed at the gNB-CU comprising:
operating the gNB-CU-UP as a plurality of CU-UP instances including a first set of CU-UP instances;
instantiating a new CU-UP instance running a modified software compared to the first set of CU-UP instances;
receiving, at a control plane entity of the gNB-CU (gNB-CU-CP), instructions to modify selection policy for distributing a user plane workload between the new CU-UP instance and the first set of CU-UP instances by adjusting the amount of the user plane workload to be allocated to the new CU-UP instance;
instantiating a second set of CU-UP instances comprising a plurality of CU-UP instances running said modified software if it is determined that the new CU-UP instance operates correctly; and
directing all user plane workload to CU-UP instances running said modified software.

2. The method according to claim 1, wherein the amount of the user plane workload assigned to the new CU-UP instance does not exceed a first threshold.

3. The method according to claim 2, further comprising increasing the first threshold defining the maximum amount of the user plane workload to be assigned to the new CU-UP instance, wherein the increase is implemented after determining that the new CU-UP instance operates correctly and before deploying the second set of CU-UP instances.

4. The method according to claim 1, further comprising
the gNB-CU-CP receiving a parameter indicating deployment of the new CU-UP instance running modified software.

5. The method according to claim 4, wherein the parameter indicating deployment of the new CU-UP instance running modified software is included in an information element dedicated to capacity of the gNB-CU-UP and/or in an information element dedicated to deployment of CU-UP instances running modified software.

6. (canceled)

7. The method according to claim 1, further comprising:
monitoring by the gNB-CU-UP at least one Key Performance Indicator, KPI, of the new CU-UP instance.

8. The method according to claim 7, wherein the operation of monitoring of the at least one KPI is carried out by the new CU-UP instance.

9. The method according to claim 7 further comprising sending the obtained KPI information to a management system.

10. The method according to claim 7, further comprising sending the obtained KPI information to an operator of a communications network where the gNodeB operates.

11. The method according to claim 7, wherein determining that the new CU-UP instance operates correctly comprises determining that the at least one Key Performance Indicator reached a threshold.

12. A Central Unit of a gNodeB, gNB-CU, for assigning a user plane workload during canary deployment of software modification of the gNB-CU, wherein processing a user plane workload is carried out by a user plane entity of the gNB-CU, gNB-CU-UP, the gNB-CU comprising a processing circuitry and a memory, the memory having stored thereon instructions executable by the processing circuitry such that the gNB-CU is operative during the canary deployment of the software modification to:
operate the gNB-CU-UP as a plurality of CU-UP instances including a first set of CU-UP instances;
instantiate a new CU-UP instance running a modified software compared to the first set of CU-UP instances;
receive, at a control plane entity of the gNB-CU (gNB-CU-CP), instructions to modify selection policy for distributing a user plane workload between the new CU-UP instance and the first set of CU-UP instances by adjusting the amount of the user plane workload to be allocated to the new CU-UP instance;
deploy a second set of CU-UP instances comprising a plurality of CU-UP instances running said modified software if it is determined that the new CU-UP instance operates correctly; and
direct all user plane workload to CU-UP instances running said modified software.

13. The gNB-CU according to claim 12, wherein the amount of the user plane workload assigned to the new CU-UP instance does not exceed a threshold.

14. The gNB-CU according to claim 13, further configured to increase the threshold defining the maximum amount of the user plane workload to be assigned to the new CU-UP instance, wherein the increase is implemented after determining that the new CU-UP instance operates correctly and before deploying the second set of CU-UP instances.

15. The gNB-CU according to claim 12, wherein the gNB-CU-CP is configured to receive a parameter indicating deployment of the new CU-UP instance running modified software.

16. The gNB-CU according to claim 15, wherein the parameter indicating deployment of the new CU-UP instance running modified software is included in an information element dedicated to capacity of the gNB-CU-UP and/or in an information element dedicated to deployment of CU-UP instances running modified software.

17. (canceled)

18. The gNB-CU according to claim 12, wherein the gNB-CU-UP is configured to monitor at least one Key Performance Indicator, KPI, of the new CU-UP instance.

19. The gNB-CU according to claim 18, wherein the new CU-UP instance is configured to monitor the at least one Key Performance Indicator, KPI, of the new CU-UP instance.

20. The gNB-CU according to claim 18 further configured to send the obtained KPI information to a management system.

21. The gNB-CU according to claim 18 further configured to send the obtained KPI information to an operator of a communications network where the gNodeB operates.

22. The gNB-CU according to claim 18 further configured to determine that the at least one Key Performance Indicator reached a threshold.
